(19) United States
(12) Patent Application Publication
(10) Pub. No.: US 2018/0012237 A1
(43) Pub. Date: Jan. 11, 2018

(54) INFERRING USER DEMOGRAPHICS THROUGH CATEGORIZATION OF SOCIAL MEDIA DATA

(71) Applicant: International Business Machines Corporation, Armonk, NY (US)

(72) Inventors: Sophia Krasikov, Katonah, NY (US); Krishna Ratakonda, Yorktown Heights, NY (US); Harini Srinivasan, Tarrytown, NY (US); Bowen Yu, Minneapolis, MN (US)

(21) Appl. No.: 15/204,159

(22) Filed: Jul. 7, 2016

(51) Int. Cl. G06Q 30/02; H04L 29/08; G06Q 50/00

(52) U.S. Cl. CPC G06Q 30/0201; G06Q 50/01; H04L 67/306

(57) ABSTRACT

Embodiments include method, systems and computer program products for inferring user demographic groups through categorization of social media data. Aspects include receiving, by a processor, unknown user data made up of social media data and social media metadata for an unknown user. Also, aspects include analyzing the unknown user data to determine features of the unknown user data that indicate the unknown user belongs to a demographic group. Next, aspects include analyzing, via a machine learning algorithm, the features of the unknown user data to determine a confidence level for the unknown user belonging to each demographic group and updating a user demographics database based upon the confidence level for the unknown user belonging to each demographic group.

### BACKGROUND

The present disclosure relates to social media applications and, more specifically, to methods, systems and computer program products for inferring user demographics through categorization of social media data.

Social media services, such as Twitter®, Facebook®, and Instagram®, generate unstructured data through their users creating posts containing text, URLs and images, as well as metadata. Users of these social media services can post these short text messages on a variety of topics and life events. Business organizations are increasingly recognizing the importance of using social media to monitor trends, better understand their customers, and market to customers in more personalized ways.

Automatic recognition of user demographics such as cultural group from these short text messages and social media profiles has a broad range of applications, such as security, marketing, and education. Cultural group, as one of the demographic groups inferred from social media, can be used to better serve the needs and requests of individuals based on a user's cultural background. The cultural group of a social media user can be determined from certain characteristics of social chatter and from networks that are common to users within the same or similar cultural groups.

### SUMMARY

Embodiments include a computer implemented method for inferring user demographics through categorization of social media data, the method includes receiving, by a processor, unknown user data made up of social media data and social media metadata for an unknown user. Also, the method includes analyzing the unknown user data to determine features of the unknown user data that indicate the unknown user belongs to a demographic group. Next, the method includes analyzing, via a machine learning algorithm, the features of the unknown user data to determine a confidence level for the unknown user belonging to each demographic group and updating a user demographics database based upon the confidence level for the unknown user belonging to each demographic group.

Embodiments include a computer system for inferring user demographics though categorization of social media data, the computer system including a processor, the processor configured to perform a method. The method includes receiving, by a processor, unknown user data made up of social media data and social media metadata for an unknown user. Also, the method includes analyzing the unknown user data to determine features of the unknown user data that indicate the unknown user belongs to a demographic group. Next, the method includes analyzing, via a machine learning algorithm, the features of the unknown user data to determine a confidence level for the unknown user belonging to each demographic group and updating a user demographics database based upon the confidence level for the unknown user belonging to each demographic group.

Embodiments also include a computer program product for inferring user demographics though categorization of social media data, the computer program product including a non-transitory computer readable storage medium having computer readable program code embodied therewith. The computer readable program code including computer readable program code configured to perform a method. The method includes receiving, by a processor, unknown user data made up of social media data and social media metadata for an unknown user. Also, the method includes analyzing the unknown user data to determine features of the unknown user data that indicate the unknown user belongs to a demographic group. Next, the method includes analyzing, via a machine learning algorithm, the features of the unknown user data to determine a confidence level for the unknown user belonging to each demographic group and updating a user demographics database based upon the confidence level for the unknown user belonging to each demographic group.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 illustrates a block diagram of a computer system for use in practicing the teachings herein;

FIG. 4 illustrates a block diagram of a system for inferring user demographics through categorization of social media data in accordance with an embodiment;

FIG. 5 illustrates a flow diagram of a method for inferring user demographics through categorization of social media data in accordance with an embodiment; and

FIG. 6 is a block diagram illustrating a system for building a machine learning model according to one or more embodiments.

### DETAILED DESCRIPTION

In accordance with exemplary embodiments of the disclosure, methods, systems and computer program products for inferring user demographics through categorization of social media data are provided. In one or more embodiments, methods for inferring user demographics through categorization of social media data include receiving social media data and metadata associated with a user and analyzing this data and metadata utilizing one or more statistical classification models. A confidence level for a user belonging to one or more demographic groups is developed. Based upon the user belonging to a demographic group and the confidence level associated with the user belonging to this demographic group, targeted content can be provided to the social media user. Targeted content providers can purchase a user's inferred demographic information and the payment amounts would vary based upon the confidence level.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

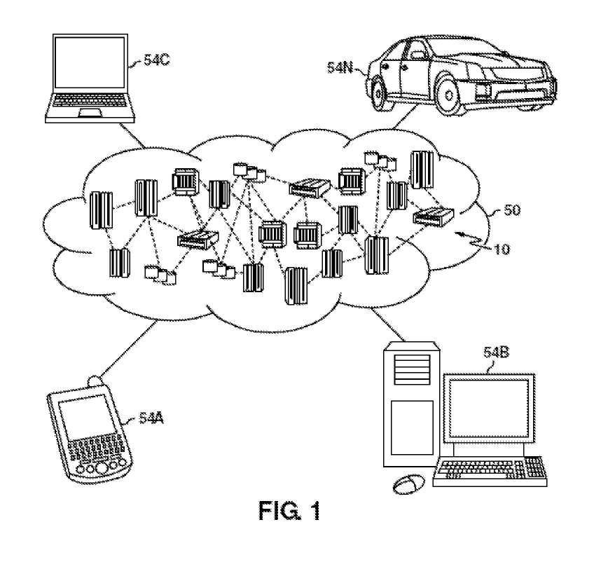

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

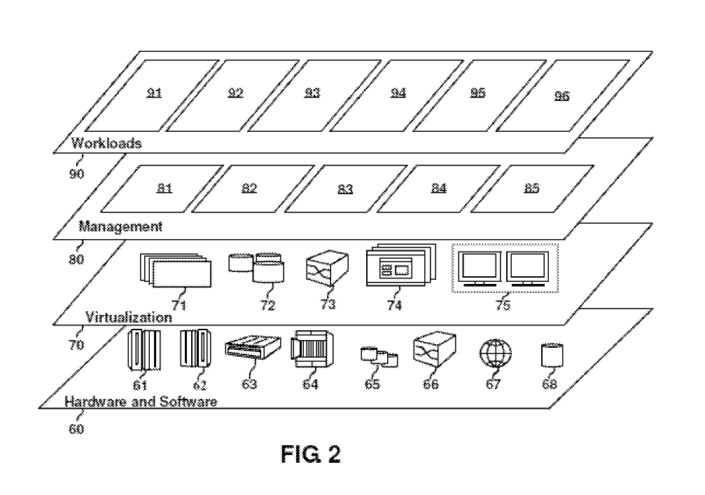

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and inferring user demographics through categorization of social media data 96.

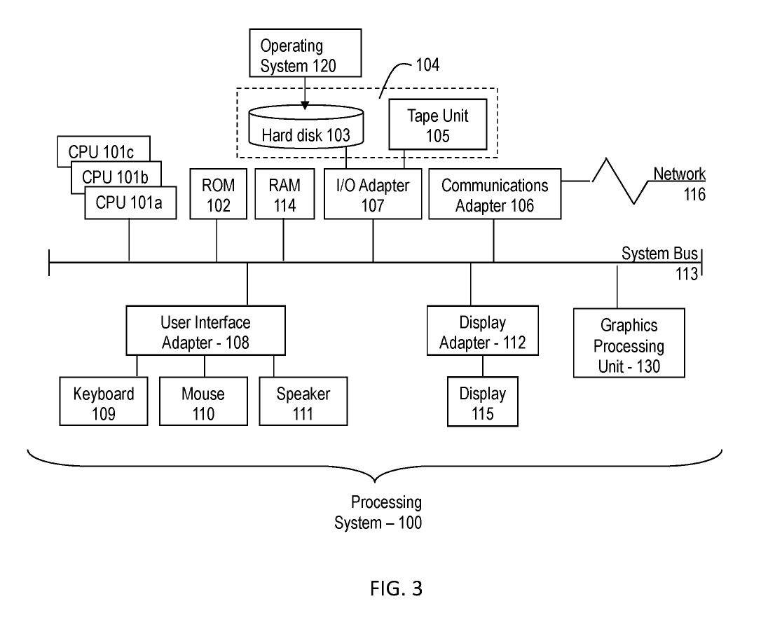

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system coordinate the functions of the various components shown in FIG. 3.

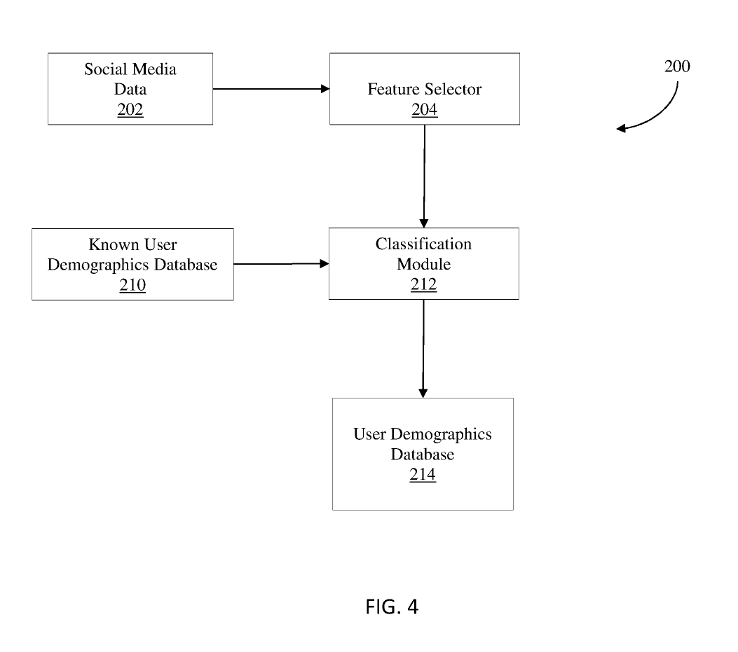

FIG. 4 is a block diagram illustrating a system 200 for inferring user demographics through categorization of social media data according to one or more embodiments. As shown in FIG. 4, the system 200 includes social media data 202, a feature selector 204, a known user attribute database 210, a classification module 212, and a user demographics database 214.

In one or more embodiments, the social media data 202 can include user interactions with the social media service such as a user post. A user post includes content in the form of the user's own words in a text format, URLs or links to websites, images or pictures, and metadata. The metadata can include certain attributes of a social media post such as an indication of an original post of social media content versus a re-post of another user's content. Additionally, metadata includes attributes such as number of users indicating an affinity towards the social media post, number of users reposting the social media post, number of users that are following a particular user, the location of the user who made a post, number and type of metadata tags, such as hashtags, used in a user post, and the like. A user may have followers of their social media posts and profile or a user may follow another user's social media posts and profile. For example, a user may be a fan of a particular celebrity. The celebrity may often post on a social media website and a user may follow or subscribe to the celebrity's posts so that they are notified of new posts and can comment or re-post the celebrity's posts. The classification module 212 can classify known demographics of a celebrity that the user is following to determine a confidence level of the user belonging to the same or similar demographic groups. For example, a user's ethnicity may be determined with a confidence level based upon the ethnicity of the celebrities that the user follows or mentions in the user's posts. In addition, the classification module 212 can classify culturally significant current events, such as for example, a religious holiday to determine a confidence level of a user's religious affiliation based upon the user posting about or utilizing a “hashtag” about the religious holiday.

In one or more embodiment, the social media data includes a user profile. A user's profile includes information about the user such as name and other demographic information. Demographic information includes but is not limited to name, surname, age, male, female, ethnicity, nationality, religious or political affiliation, income level, education level, and more. Additionally, a demographic group is a group defined by criteria such as education, nationality, religion and ethnicity.

In one or more embodiments, the social media data 202 is sent to a feature selector 204. The feature selector 204 analyzes the social media data 202 to identify and select one or more features of the social media data 202 that are considered to be strong classification indicators that tend to show that a user belongs to certain demographic groups. A strong classification indicator can be attributes about a user's social media usage such as the use of hashtags, mentions of celebrities belonging to a certain demographic group, presence of URLs in user posts, posting frequency, re-posting amount compared to posting amount, number of followers of the user, number of people the user is following, density of a user's social media network, and how posts spread and circulate within a user's social media network. For example, when selecting features that would be indicative of a user's ethnicity, the feature selector 204 may choose mentions of celebrities of the same ethnicity as the user in posts by the user as a strong classification indicator to help identify or classify the user into an ethnicity group.

In one or more embodiments, the feature selector 204 identifies features that are analyzed by the classification module 212. The classification module 212 can utilize a statistical classification algorithm to analyze the features of the social media data 202 to develop or determine a confidence level for a particular user belonging to one or more demographic groups. Based upon this confidence level, the user demographics database 214 is updated for the user showing a confidence level for multiple demographic groups for the user.

In one more embodiments, the system 200 includes a known user demographics database 210. The known user demographics database 210 stores demographic information that is known for multiple users. For example, much of the demographic group information for celebrities is known to the public such as age, male, female, ethnic origin, income level and the like. Certain demographic group information such as religious or political affiliation of a celebrity may be known and stored in the user demographics database 210. Additionally, the known user demographics database 210 may store demographic information of a user that was self-identified by the user such as demographic information found in the user's social media profile.

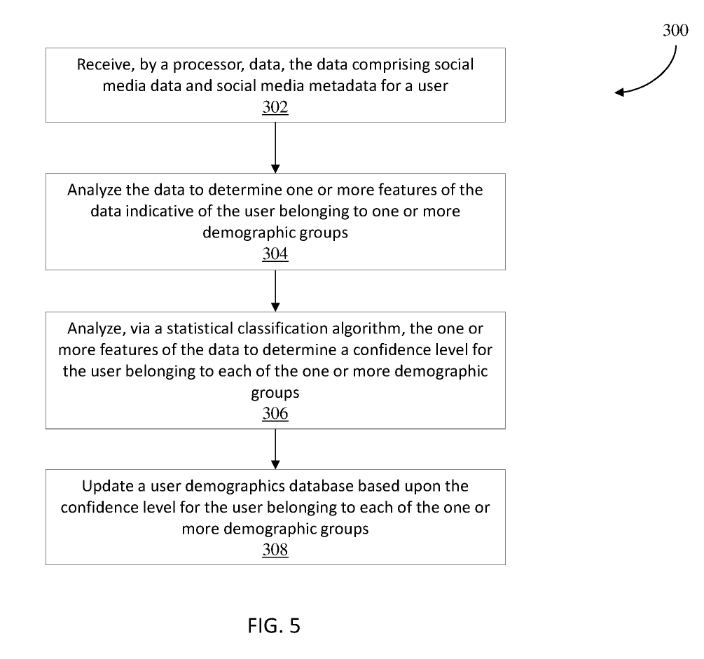

FIG. 5 illustrates a flow diagram of a method 300 for inferring user demographic groups through categorization of social media data according to one or more embodiments. As shown in block 302, the method 300 includes receiving, by a processor, data, the data comprising social media data and social media metadata for a user. Next, at block 304, the method 300 includes analyzing the data to determine one or more features of the data indicative of the user belonging to one or more demographic groups. Next, the method 300 includes analyzing, via a statistical classification algorithm, the one or more features of the data to determine a confidence level for the user belonging to each of the one or more demographic groups, as shown at block 306. Next, at block 308, the method includes updating a user demographics database based upon the confidence level for the user belonging to each of the one or more demographic groups.

Additional processes may also be included. It should be understood that the processes depicted in FIG. 5 represent illustrations, and that other processes may be added or existing processes may be removed, modified, or rearranged without departing from the scope and spirit of the present disclosure.

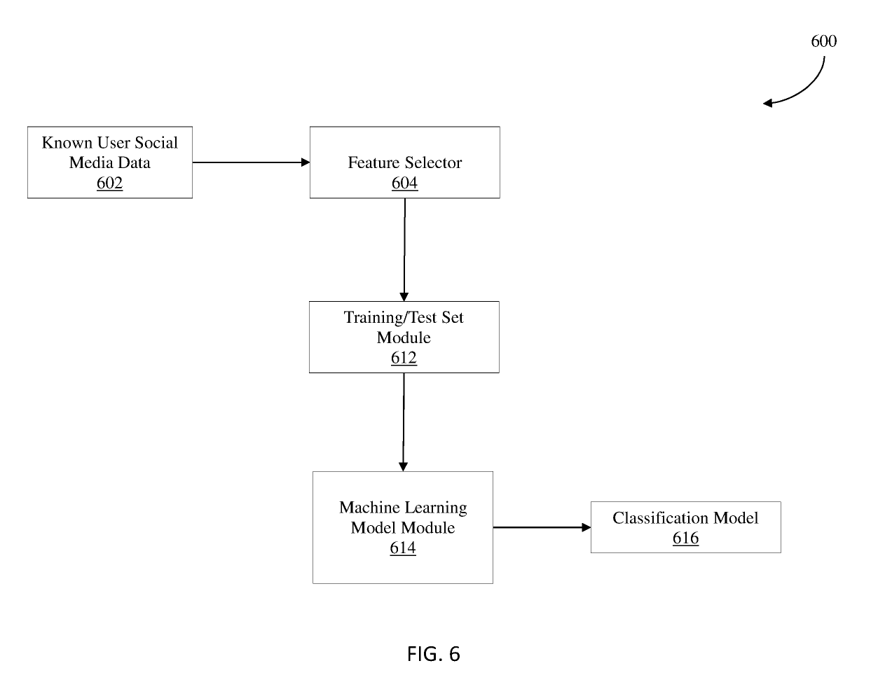

FIG. 6 is a block diagram illustrating a system 600 for building a machine learning model according to one or more embodiments. As shown in FIG. 6, the system 600 includes known user social media data 602, a feature selector 604, a training/test set module 612, a machine learning model module 614, and a learned module 616.

In one or more embodiment, known user social media data 602 is obtained from a social media service as an original data set. The feature selector 604 selects features that are considered user demographic indicators (such as surname, follows of a particular celebrity, etc.) from this known social media data 602. The training/test set module 612 splits this data into a training and test set. The machine learning model module 614 uses the training set to train and tune a machine learning model and uses test set to validate the predicting accuracy of the trained model. The classification model 616 is created once a threshold accuracy is obtained from the training models, and this classification model 616 can be used to infer user demographics from social media data. In one or more embodiments, the classification model 616 can be utilized by the classification module 212 from FIG. 4.

In one or more embodiments, the confidence level determined by the statistical classification algorithm can be a range, such as confidence interval. For example, a demographic group such as education level may be a range of values such as a confidence level between 50%-70% that a user has at least a high school education based upon an analysis of the social media data 202. Additionally, the confidence level can be just a percentage such as a confidence level of 78% that the user is affiliated with a certain political group based upon the social media data 202. Additionally, the confidence level of demographic groups that are self-identified in the user's profile can be set at 100%.

In one or more embodiments, the user demographics database 214 stores user demographic information including a user belonging to one or more demographic groups. Additionally, the user demographics database stores the confidence level that a user belongs to one or more demographics group, such as religious, political or ethnic groups. For example, a user may have a confidence level of 40% inferring the user belongs to the green party political group based upon the user's social media data 202. The user demographics database 214 can require a threshold confidence level for storing a user's demographic information. For example, the database may require a confidence level of at least 60% before it will store a user's demographic group category. Additionally, different demographic groups may require a higher or lower threshold before the database stores the user's demographic information. For example, sensitive demographic information such as religious affiliation may require a higher threshold in confidence level before being stored in the user demographics database.

In one or more embodiments, targeted content may be directed to a user based upon demographic information of the user. Specifically, targeted content for a specific demographic group may be presented to a user based upon the user belonging to the demographic group and based upon the confidence level of the user belonging to the demographic group. Targeted content can include advertisements, website links to organizations, and links to social media groups that a user may find of interest based upon the user belonging to a certain demographic group. For example, users belonging to a certain age group may be targeted with content regarding colleges and other education options that may be of interest to the users.

In one or more embodiments, a targeted content provider, such as advertisement agency, may purchase user demographics identified by the system 200. The purchase price can be tied to the confidence level of the user's demographic information. For example, an advertiser may request users within a certain income level demographic and would want a confidence level of at least 75%. The advertiser would pay more for a higher confidence level and pay less for a lower confidence level. In one or more embodiments, pricing levels can be based upon a range of confidence levels for certain user demographics. For example, a targeted content provider may pay for users falling within a demographic group with a confidence level between 50%-75%.

In one or more embodiments, an image of a user may be analyzed to determine if a user belongs to a demographic group. User images can be found in the user's profile or in certain posts by the user indicating that they are the subject of the image.

In one or more embodiments, the classification module 212 can increase the confidence level of a user belonging to certain demographic groups based upon known information about the user, such as a surname. Certain surnames, based upon census data, are more likely to belong to certain ethnic or cultural groups. Based upon the surnames, a confidence level can be raised or lowered when compared to census data.

In one or more embodiments, the classification module 212 can determine that a user belongs to one or more demographic groups by using a test set of data and a training set of data. A training set is a set of data used to discover potentially predictive relationships. A test set is a set of data used to assess the strength and utility of a predictive relationship. These sets may be used in machine learning, intelligent systems, genetic programming and statistics. The training and test data can determine a confidence level using an applied machine learning algorithm to construct a predictive model based upon one or more features of a user's social media data and social media metadata. A regression analysis can be used to increase the confidence level of the user belonging to one or more demographic groups.

One of ordinary skill in the art can appreciate that for social media users of all demographic groups tend to follow and re-post celebrities, politicians, bloggers, and activists belonging to the same or similar demographic group of the user.

In one or more embodiments, the system 200 may not have complete information from the social media data 202 (i.e. a value for a feature). The system 200 can employ imputation techniques to improve a training dataset to achieve a higher confidence level. Imputation techniques (i.e. substitution of missing values) include k nearest neighbor imputation and random forest imputation.

In one or more embodiments, the system 200 can employ machine learning algorithms for classification of users belonging to a demographic group. Machine learning techniques include Random Forests, Decision Tree, Ada boost, SVM, k nearest neighbors, and Naïve Bayes.

In one or more embodiments, the system 200 can convert multi-class classification into a combination of several binary classifications. An example of a binary classification that can be employed includes a one-against-all approach. A classification of a user into a demographic group can be done by choosing the best classifier among all the classifiers, aggregating the prediction from each classifier and comparing the user's social media data features with an expected social media data features of a certain demographic group.

In one or more embodiments, the system 200 may employ a greedy-based sequential binary classification model to classify a user into a demographic group. This model uses the one-against-all decomposition strategy for each binary classification and chooses the best split as the decomposition for that iteration. This is done iteratively until all the classes are classified.

In one or more embodiments, the system 200 may employ one or multiple classification models to determine a confidence level of a social media user belonging to one or more demographic groups.

In one or more embodiments, the system 200 can infer more than the user belonging to a demographic groups such as inferring a user's preferences, interests, and habits across and within demographic groups. For examples, interests in certain current events may transcend several demographic groups.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method of inferring user demographics through categorization of social media data, the method comprising:
receiving, by a processor, unknown user data comprising social media data and social media metadata for an unknown user;
analyzing the unknown user data to determine one or more features of the unknown user data indicative of the unknown user belonging to one or more demographic groups;
analyzing, via a machine learning algorithm, the one or more features of the unknown user data to determine a confidence level for the unknown user belonging to each of the one or more demographic groups; and
updating a user demographics database based upon the confidence level for the unknown user belonging to each of the one or more demographic groups.

2. The method of claim 1, wherein the machine learning algorithm is built by a method comprising:
receiving, by the processor, known user data comprising social media data, social media metadata, and user demographic information for a known user;
analyzing the known user data to determine one or more features of the known user data indicative of the known user belonging to one or more demographic groups;
constructing a training data set and a test data set from the known user data and the one or more features;
training a classifier using the training set;
testing the classifier using the test set; and
building the machine learning algorithm based upon a result of the training and testing of the classifier.

3. The method of claim 1, further comprising:
receiving, by a processor, profile data comprising user identified demographic information;
adjusting the confidence level for the user belonging to one or more demographic groups based upon the profile data.

4. The method of claim 1, further comprising:
providing targeted content to the user based on the confidence level for the user belonging to each of the one or more demographic groups.

5. The method of claim 1, wherein the confidence level is a range showing a percentage likelihood of a user belonging to each of the one or more user demographic groups.

6. The method of claim 4, further comprising:
receiving a payment amount, from a targeted content provider, for providing the targeted content to the user.

7. The method of claim 6, wherein the payment amount is based upon the confidence level for the user belonging to each of the one or more demographic groups.

8. The method of claim 1, wherein the user demographics database is updated when the confidence level exceeds a threshold level.

9. The method of claim 8, wherein the threshold level varies based upon the one or more demographic groups.

10. The method of claim 3, wherein the user profile includes an image of the user.

11. The method of claim 10, further comprising:
adjusting the confidence level for the user belonging to one or more demographic groups based upon the image of the user; and
updating the user demographics database based upon the confidence level for the user belonging to one or more demographic groups based upon the image of the user.

12. The method of claim 1, wherein the one or more features include one or more followers of the user.

13. The method of claim 12, further comprising:
receiving follower profile data for each of the one or more followers of the user, wherein the follower profile data for each of the one or more followers of the user comprises follower demographic groups selected by the one or more followers; and
adjusting the confidence level for the user belonging to each of the one or more demographic groups based upon the follower profile data.

14. A system for inferring user demographics through categorization of social media data, the system comprising:
a processor configured to:
receive data, the data comprising social media data and social media metadata for a user;
analyze the data to determine one or more features of the data indicative of the user belonging to one or more demographic groups;
analyze, via a machine learning algorithm, the one or more features of the data to determine a confidence level for the user belonging to each of the one or more demographic groups; and
update a user demographics database based upon the confidence level for the user belonging to each of the one or more demographic groups.

15. The system of claim 14, wherein the machine learning algorithm is built by a method comprising:
receiving, by the processor, known user data comprising social media data, social media metadata, and user demographic information for a known user;
analyzing the known user data to determine one or more features of the known user data indicative of the known user belonging to one or more demographic groups;
constructing a training data set and a test data set from the known user data and the one or more features;
training a classifier using the training set;
testing the classifier using the test set; and
building the machine learning algorithm based upon a result of the training and testing of the classifier.

16. The system of claim 14, further comprising:
the processor configured to:
receive profile data comprising one or more demographic groups selected by the user; and
adjust the confidence level for the user belonging to each of the one or more demographic groups based upon the profile data.

17. The system of claim 14, further comprising:
the processor configured to:
provide targeted content to the user based on the confidence level for the user belonging to each of the one or more demographic groups.

18. A computer program product for inferring user demographics through categorization of social media data, the computer program product comprising a computer readable storage medium having program instructions embodied therewith, wherein the computer readable storage medium is not a transitory signal per se, the program instructions executable by a processor to cause the processor to perform a method comprising:
receiving data, the data comprising social media data and social media metadata for a user;
analyzing the data to determine one or more features of the data indicative of the user belonging to one or more demographic groups;
analyzing, via a machine learning algorithm, the one or more features of the data to determine a confidence level for the user belonging to each of the one or more demographic groups; and
updating a user demographics database based upon the confidence level for the user belonging to each of the one or more demographic groups.

19. The computer program product of claim 18, wherein the machine learning algorithm is built by a method comprising:
receiving, by the processor, known user data comprising social media data, social media metadata, and user demographic information for a known user;
analyzing the known user data to determine one or more features of the known user data indicative of the known user belonging to one or more demographic groups;
constructing a training data set and a test data set from the known user data and the one or more features;
training a classifier using the training set;
testing the classifier using the test set; and
building the machine learning algorithm based upon a result of the training and testing of the classifier.

20. The computer program product of claim 18, further comprising:
providing targeted content to the user based on the confidence level for the user belonging to each of the one or more demographic groups.
